(19) United States
(12) Patent Application Publication
(10) Pub. No.: US 2008/0305796 A1
(43) Pub. Date: Dec. 11, 2008

(54) Method for performing inter-technology handovers utilizing tunnels

(76) Inventor: Michael Francis Dolan, Bolingbrook, IL (US)

Correspondence Address: Alcatel-Lucent;Docket Administrator, Room 2F-190, 600-700 Mountain Ave, P.O. Box 636, Murray Hill, NJ, 07733-3030, US

(21) Appl. No.: 11/810,161

(22) Filed: Jun. 5, 2007

(51) Int. Cl. H04Q 7/20

(52) U.S. Cl. 455/436

(57) ABSTRACT

The present invention provides a method for performing inter-technology handovers of a communication unit between a first Radio Access Network (RAN) and a second RAN. The communication unit includes a single transceiver. An inter-RAN tunnel is established between the first RAN and the second RAN. When the communication unit determines that it may be moving out of the service area of the first RAN, the communication unit sends a handover request message to the first RAN. The handover request message includes a request for a second RAN that the communication unit can communicate with. The communication unit is then able to perform some handover communication with the second RAN prior to actually handing off to the second RAN, by utilizing the inter-RAN tunnel between the first RAN and the second RAN.

### FIELD OF THE INVENTION

The present invention relates generally to wireless communication systems, and more particularly to handovers between communication systems.

### BACKGROUND OF THE INVENTION

When a mobile phone is operating on one radio technology and comes to the end of the coverage area for that technology, the connection for the mobile phone must be handed over to another radio technology. Such handovers are very important in real-time services, such as voice calls.

When there is only a single transceiver in a mobile phone, such that it cannot communicate on two technologies simultaneously, it must leave the first technology, initiate a session on the second technology, and an authenticated context must be established before the service can be continued on the second technology. This establishment time on the second technology can take as long as several seconds, and thus is not useful for real-time service inter-technology handovers.

One solution to this problem is to use a very slow handover between the two systems. This is not very practical, since it leads to discontinuity in voice calls and the potential for members of the call to end the call, thinking that the other party has ended the conversation.

A second proposed solution is to predefine a communication protocol between the disparate technologies. This protocol for exchanging calls is specific to each technology pair, and would need to be tailored and modified for each and every technology to have an associated protocol with every other communication technology in existence. If one technology changed, or a new technology came online, major changes would be necessary to all other communication networks.

A further way of dealing with this problem is to simply drop the call. This is not much of a solution to the problem, however.

Therefore, a need exists for a method of performing handover of voice calls from a network using a first technology to a network using a second technology when a mobile unit includes a single transceiver.

### BRIEF SUMMARY OF THE INVENTION

The present invention provides a solution to the problems of the prior art by using a generic tunneling approach to send signaling between a mobile phone and a second RAN using a technology different than the first RAN that the mobile unit is currently using. Signaling and data are sent in both directions between the second RAN and the mobile phone using the radio link of the first RAN.

The present invention thereby provides for inter-technology handovers in a way that allows independence of the radio technologies and their evolution paths. Changes in a radio technology do not impact other technologies with which inter-technology handovers are executed.

Because the mobile can begin to exchange signaling with another RAN before actually acquiring the radio channels of that RAN, handover delays for single radio mobiles can be shortened significantly to support real time services such as voice.

### BRIEF DESCRIPTION OF THE SEVERAL VIEWS OF THE DRAWINGS

FIG. 1 depicts a communication system that includes a first radio access network (RAN), a second RAN, an inter-RAN tunnel, and a radio interface tunnel in accordance with an exemplary embodiment of the present invention.

FIG. 2 depicts a message flow between a communication unit, a first RAN, and a second RAN in accordance with an exemplary embodiment of the present invention.

### DETAILED DESCRIPTION OF THE INVENTION

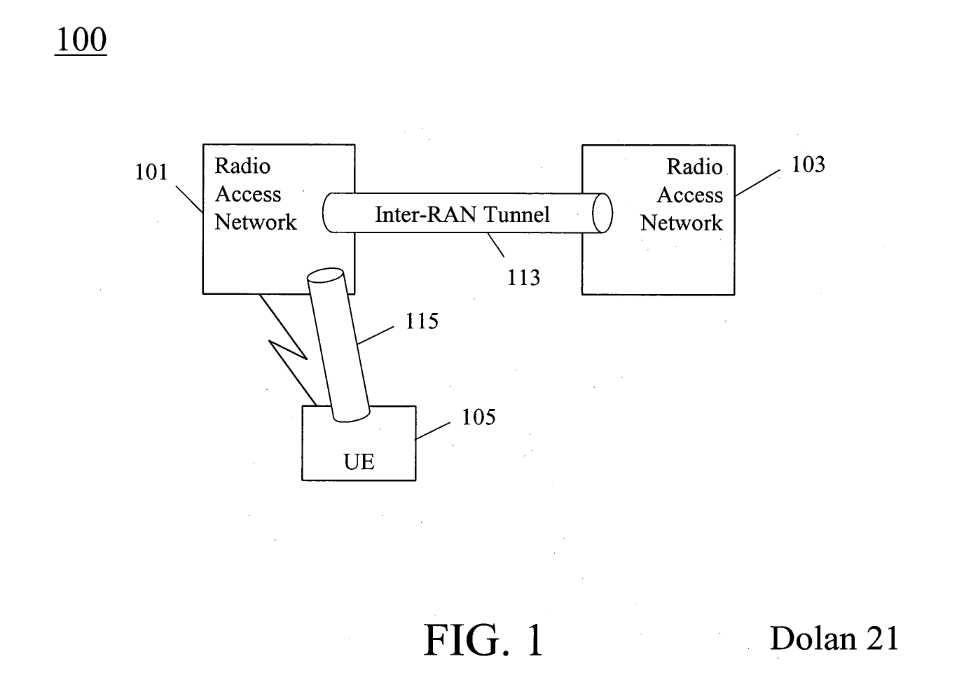

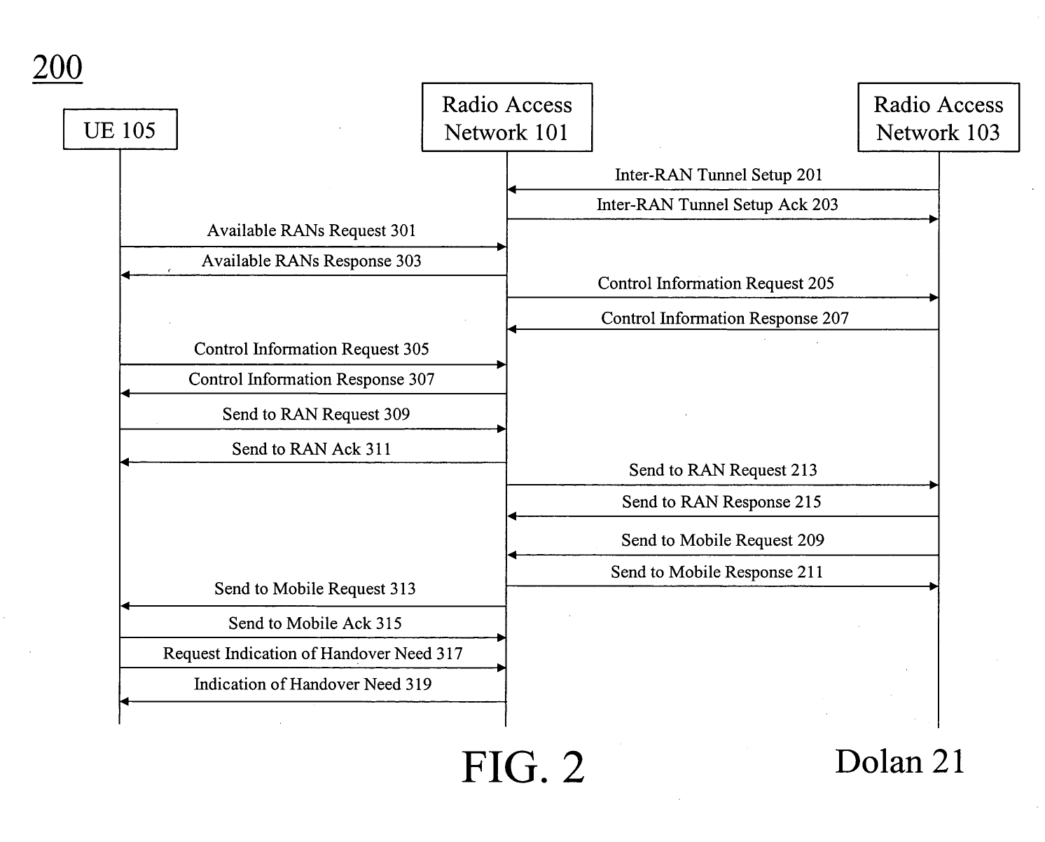

The present invention provides a method for performing inter-technology handovers using generic tunneling. The present invention can be better understand in reference to FIGS. 1 and 2

FIG. 1 depicts a communication system 100 that includes a first radio access network (RAN) 101, a second RAN 103, an inter-RAN tunnel 113, and a radio interface tunnel 115. User equipment 105 is coupled to communication system 100 via RAN 101. FIG. 1 depicts a high-level view of the generic tunneling approach proposed by the present invention.

First RAN 101 and second RAN 103 are radio access networks. Radio access networks manage the radio resources and provide access to a core network or a packet-switched network. First RAN 101 and second RAN 103 are preferably the ground-based infrastructure required for delivery of third-generation (3G) wireless communications services, including high-speed mobile access to the Internet. First RAN 101 and second RAN 103 preferably manage a wide range of tasks for each 3G user, including access, roaming, transparent connection to the public switched telephone network and the Internet, and Quality of Service (QoS) management for data and Web connections.

Inter-RAN tunnel 113 provides communication between first RAN 101 and second RAN 103. Inter-RAN tunnel 113 is a generic tunnel that facilitates communication between UE 105 and second RAN 103. In accordance with an exemplary embodiment of the present invention, UE 105 is communicating over the air with first RAN 101. Upon leaving the service area of first RAN 101 and traveling into the service area of second RAN 103, UE 105, which in this exemplary embodiment has a single transceiver, cannot simultaneously communicate with both first RAN 101 and second RAN 103. In accordance with an exemplary embodiment of the present invention, UE 105 utilizes radio interface tunnel 115 to send and receive handover information to first RAN 101. First RAN 101 forwards this information to second RAN 103 via inter-RAN tunnel 113.

Radio interface tunnel 115 is defined by the radio interface technology between first RAN 101 and UE 105. Each over-the-air technology preferably defines radio interface tunnel 115 to suit the design of the particular radio interface.

Radio interface tunnel 115 preferably provides for communication from UE 105 to first RAN 101 and from first RAN 101 to UE 105. In an exemplary embodiment, UE 105 sends various messages to first RAN 101 via radio interface tunnel 115, such as a request for a list of RANs available for handover, a request for a set of control information for the available RAN, a request to send content to a different RAN, a request for an estimate of the time a handover would require, and various acknowledgements of messages received from first RAN 101.

In an exemplary embodiment, first RAN 101 sends various message to UE 105 via radio interface tunnel 115, such as a list of RANs available to handover to, a set of control information for an available RAN, content from second RAN 103, the approximate time until there is a probable need for a handover to a different technology, and various acknowledgement messages.

In accordance with an exemplary embodiment, first RAN 101 defines the protocol to be used for radio interface tunnel 115 and second RAN 103 defines the signaling and procedures to be used for inter-RAN tunnel 113. Inter-RAN tunnel 113 preferably utilizes a simple, standard protocol in order to enlarge the number of technologies that can communicate with other RANs and the applicability of the present invention.

User equipment (UE) 105 is a portable communication device that allows communication between itself and other users of communication networks. UE 105 can be a communication unit, a mobile phone, a cellular phone, a pager, or any other communication device that is capable of two-way communication. In accordance with an exemplary embodiment, UE 105 includes a single transceiver, and therefore is not able to tune away from first. RAN 101 for a long enough period to search for other available RANs.

FIG. 2 depicts a message flow 200 between communication unit 105, first RAN 101, and second RAN 103 utilizing generic tunnels in accordance with an exemplary embodiment of the present invention.

Inter-RAN Tunnel Setup message 201 begins inter-RAN tunnel establishment. Inter-RAN Tunnel Setup message 201 preferably includes an identification of the RAN and the type of RAN. Although Inter-RAN Tunnel Setup message 201 is depicted as flowing from second RAN 103 to first RAN 101, it can alternately be initiated by first RAN 101.

Inter-RAN Tunnel Setup Ack message 203 completes inter-RAN tunnel establishment. Inter-RAN Tunnel Setup Ack message 203 preferably includes the ID of the RAN and the type of RAN. Inter-RAN Tunnel Setup Ack message 203 completes the establishment of a generic tunnel, inter-RAN tunnel 113, between first RAN 101 and second RAN 103. Both first RAN 101 and second RAN 103 will receive and store the RAN ID and RAN type of the other RAN.

Available RANs Request message 301 requests a list of available RANs with a RAN-ID and a RAN-Type for each.

Available RANs Response message 303 provides a list of available RANs with a RAN-ID and a RAN-Type for each. As an example, available RANs response message 303 could include the RAN ID and RAN type of second RAN 103.

Control Information Request message 205 is sent from first RAN 101 to second RAN 103 and requests a set of control information from second RAN 103 in the format used by that RAN type. When first RAN 101 receives Control Information Request message 205 from UE 105, it preferably formats an inter-RAN Control Information Request to be sent to another RAN. When first RAN 101 receives a Control Information Response from another RAN, it can pass that information on to any mobile requesting the information.

Control Information Response message 207 provides a set of control information for second RAN 103 in the format used by that RAN type, and can be sent autonomously. Control Information Response message 207 preferably includes RAN-ID, RAN-Type, and RAN-Info.

Control Information Request message 205 and Control Information Response message 207 complete the function of obtaining control information for UE 105.

Control Information Request message 305 requests a set of control information for the indicated RAN in the format used by that RAN type. Control Information Request message 305 preferably includes RAN-ID.

Control Information Response message 307 provides a set of control information for the RAN indicated in the format used by that RAN type. Control Information Response message 307 preferably includes RAN-ID.

Send to RAN Request message 309 is used to send content to a different RAN, returns an Ack/Nack. Send to RAN Request message 309 preferably includes RAN-ID, Mobile-ID, Seq-No, and content.

Send to RAN Ack message 311 is used to Ack/Nack content sent from the mobile to a different RAN via the serving RAN. Send to RAN Ack message 311 preferably includes Ack/Nack and Seq-No.

Send to RAN Request message 213 is used to forward signaling/data to the targeted RAN from a mobile, returns an Ack/Nack. Send to RAN Request message 213 preferably includes Mobile-ID, Seq-No, and signaling/data.

Send to RAN Response message 215 is used to Ack/Nack a Send to RAN Request message. Send to RAN Response message 215 preferably includes Mobile-ID, SeqNo, and Ack/Nack.

Send to Mobile Request message 209 is used to send signaling/data to the mobile via a different RAN, returns an Ack/Nack. Send to Mobile Request message 209 preferably includes Mobile-ID, Seq-No, and signaling/data.

Send to Mobile Response message 211 is used to Ack/Nack a Send to Mobile Request message. Send to Mobile Response message 211 preferably includes Mobile-ID, SeqNo, and Ack/Nack.

Send to Mobile Request message 209 and Send to Mobile Response message 211 provide the ability to support a bidirectional flow of content between another non-serving RAN and UE 105.

Send to Mobile Ack message 313 is used to Ack/Nack content sent from a different RAN to the mobile via the serving RAN. Send to Mobile Ack message 313 preferably includes Ack/Nack and Seq-No.

Send to Mobile Request message 315 is used to send content received from a different RAN to the mobile, returns an Ack/Nack. Send to Mobile Request message 315 preferably includes RAN-ID, Mobile-ID, Seq-No, and signaling/data.

Request Indication of Handover Need message 317 requests an estimate of the time to handover in seconds.

Indication of Handover Need message 319 is used to indicate the approximate time in seconds until there is a probable need for handover to a different technology. Indication of Handover Need message 319 preferably includes seconds. Indication of Handover Need message 319 can also be sent autonomously by RAN 101 to indicate to UE 105 that a handover to another RAN is recommended.

While this invention has been described in terms of certain examples thereof, it is not intended that it be limited to the above description, but rather only to the extent set forth in the claims that follow.

I claim:

1. A method for performing inter-technology handovers of a communication unit between a first Radio Access Network (RAN) and a second RAN, the communication unit including a single transceiver, the method comprising:
establishing an inter-RAN tunnel between the first RAN and the second RAN;
receiving a message intended for the second RAN at the first RAN from the communication unit; and
sending the message from the first RAN to the second RAN utilizing the inter-RAN tunnel.

2. A method for performing inter-technology handovers in accordance with claim 1, wherein the step of establishing an inter-RAN tunnel between the first RAN and the second RAN is initiated by the first RAN.

3. A method for performing inter-technology handovers in accordance with claim 1, wherein the step of establishing an inter-RAN tunnel between the first RAN and the second RAN is initiated by the second RAN.

4. A method for performing inter-technology handovers in accordance with claim 1, wherein the step of establishing an inter-RAN tunnel between the first RAN and the second RAN comprises storing an identification of the second RAN at the first RAN.

5. A method for performing inter-technology handovers in accordance with claim 1, wherein the step of establishing an inter-RAN tunnel between the first RAN and the second RAN comprises storing an identification of the first RAN at the second RAN.

6. A method for performing inter-technology handovers in accordance with claim 1, wherein the message includes an identification of the second RAN.

7. A method for performing inter-technology handovers in accordance with claim 1, wherein the message includes an identification of the communication unit.

8. A method for performing inter-technology handovers in accordance with claim 1, wherein the message includes a sequence number.

9. A method for performing inter-technology handovers in accordance with claim 1, the method further comprising the step of sending a return message from the second RAN to the communication unit via the first RAN, wherein the return message is sent from the second RAN to the first RAN via the inter-RAN tunnel.

10. A method for determining a Radio Access Network (RAN) that is available for a communication unit to handover to, the method comprising:
determining that a communication unit will soon be out of the service area of a first RAN to which the communication unit is currently communicating;
sending a handover request message to the first RAN from the communication unit, the handover request message including a request for a second RAN that the communication unit can communicate with; and
switching communication of the communication unit from the first RAN to the second RAN based at least in part upon receipt of a response to the handover request message.

11. A method for determining a Radio Access Network (RAN) that is available for a communication unit to handover to in accordance with claim 10, the method further comprising the step of, in response to the sending step, receiving a list of radio access networks that are available for handover.

12. A method for determining a Radio Access Network (RAN) that is available for a communication unit to handover to in accordance with claim 11, wherein the list includes an identification and a RAN type for each radio access network.

13. A method for determining a Radio Access Network (RAN) that is available for a communication unit to handover to in accordance with claim 10, wherein the handover request message includes a request for an estimate of the time it will take to complete a handover to the second RAN.

14. A method for determining a Radio Access Network (RAN) that is available for a communication unit to handover to in accordance with claim 13, the method further comprising the step of receiving a handover time response from the in response to the handover request message.
